(19) United States
(12) Patent Application Publication
(10) Pub. No.: US 2014/0071300 A1
(43) Pub. Date: Mar. 13, 2014

(54) PORTABLE INFORMATION PRODUCT

(71) Applicant: Lu-Cheng CHEN, Taipei City (TW)

(72) Inventor: Lu-Cheng CHEN, Taipei City (TW)

(21) Appl. No.: 14/079,725

(22) Filed: Nov. 14, 2013

Related U.S. Application Data
(63) Continuation-in-part of application No. 13/070,733, filed on Mar. 24, 2011.
Application No. 13/070,733 is a continuation-in-part of application No. 11/242,848, filed on Oct. 5, 2005, now abandoned.

(30) Foreign Application Priority Data
Apr. 22, 2005 (TW) 94112990

(51) Int. Cl. H04N 1/00

(52) U.S. Cl. CPC H04N 1/00267
USPC 348/207.1

(57) ABSTRACT

A portable information product comprising: an amplifying circuit; a data processing device having a main circuit module having a microprocessor and a plurality of memories for processing data thereof and forming an output signal from the data, and having a storage device electrically connecting to the main circuit module for storing data of the data processing device, and having an application circuit module including a charging circuit module; a built-in projection device disposed in the data processing device the projection device having a light source and a projector, the projector having a imaging unit and a lens; a display device disposed in the data processing device; a switching circuit module disposed in the data processing device and electrically connecting to the projection device and the display device; a photograph module disposed in the data processing device, and electrically connecting between the lens and the switching circuit module.

### RELATED U.S. APPLICATION DATA

This is the Continuation-in-part of U.S. patent application Ser. No. 13/070,733, filed on Mar. 24, 2011, currently pending, which is a Continuation-in-Part of Ser. No. 11/242,848, filed 5 Oct. 2005, now abandoned.

### BACKGROUND OF THE INVENTION

1. Field of the Invention

The instant disclosure relates to a portable information product, and more particularly, to a portable information product having a built-in projection device.

2. Description of Related Art

The instant disclosure relates to a portable information product, and more particularly, to a portable information product having a built-in projection device. A conventional portable information product displays data thereof on a display device thereof.

The display device of the conventional portable information product has a limited size and is only designed for a single user to view. As such, it is difficult for others to view the display at the same time. It lacks practicality if a user wants to show information stored on the portable information product to others, if, as an example, they are in a conference with several people.

Additionally, it's common to take a photograph in a conference. But the conventional projector only has the projection function. To prove a convenient portable information product, it's requirement to combine the projector and the camera.

Accordingly, as discussed above, the conventional portable information product still has some drawbacks that could be improved upon. The instant disclosure aims to resolve the drawbacks in the prior art.

### SUMMARY OF THE INVENTION

The primary objective of the invention is therefore to specify a portable information product having a built-in projection device, wherein a built-in projection device is disposed in a data processing device, and the projection device outputs an output signal formed by the data processing device and outside the data processing device, so that others can view the data of the data processing device more easily.

According to the instant disclosure, the objective is achieved via a portable information product having a built-in projection device. The portable information product comprises a data processing device and a built-in projection device. The data processing device has a main circuit module for processing data thereof and forming an output signal from the data. The built-in projection device is disposed in the data processing device and electrically connects to the main circuit module. The projection device has a light source and a projector. The light source generates a light. The light and the output signal are transmitted to the projector to form an image, and the projector projects the image outside the data processing device.

The built-in projection device is disposed in the data processing device. As such, that the output signal formed by the data processing device is outputted via the projection device and others can view the data of the data processing device more easily.

Additionally, according to the instant disclosure, the objective is achieved via a portable information product capable of projecting and taking a photograph, the portable information product comprising: an amplifying circuit; a data processing device having a main circuit module having a microprocessor and a plurality of memories for processing data thereof and forming an output signal from the data, and having a storage device electrically connecting to the main circuit module for storing data of the data processing device, and having an application circuit module including a charging circuit module; a built-in projection device disposed in the data processing device the projection device having a light source and a projector, the projector having a imaging unit and a lens; a display device disposed in the data processing device; a switching circuit module disposed in the data processing device and electrically connecting to the projection device and the display device; a photograph module disposed in the data processing device, and electrically connecting between the lens and the switching circuit module; wherein the built-in projection device and the amplifying circuit module are electrically connected between the main circuit module and the projector of the projection device, and the output signal is transmitted to the projector via the amplifying circuit module, and the photograph module and the imaging unit alternatively correspond to the lens.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic block diagram of a first embodiment of an interior system according to a portable information product having the built-in projection device of the instant disclosure;

FIG. 2 is a schematic block diagram of a second embodiment of an interior system according to a portable information product having the built-in projection device of the instant disclosure;

FIG. 3 is a perspective view of a first embodiment according to a portable information product having the built-in projection device of the instant disclosure;

FIG. 4 is a perspective view of a second embodiment according to a portable information product having the built-in projection device of the instant disclosure;

FIG. 5 is a perspective view of a third embodiment according to a portable information product having the built-in projection device of the instant disclosure;

FIG. 6 is a perspective view of a fourth embodiment according to a portable information product having the built-in projection device of the instant disclosure.

FIG. 7 is a schematic block diagram of a third embodiment of an interior system according to a portable information product having the built-in projection device of the instant disclosure;

FIG. 8 is a schematic block diagram of a third embodiment of the distance measuring device of the instant disclosure;

FIG. 9 is a perspective view of a third embodiment according to a portable information product having the built-in projection device of the instant disclosure;

FIG. 10 is a schematic block diagram of a forth embodiment of an interior system according to a portable information product having the built-in projection device of the instant disclosure; and

FIG. 11 is a perspective view of a third embodiment according to a portable information product having the built-in projection device of the instant disclosure.

### DETAILED DESCRIPTION OF THE PREFERRED EMBODIMENTS

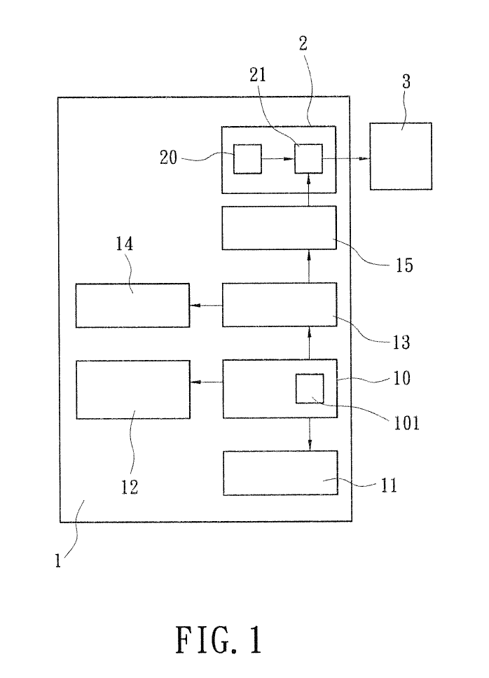

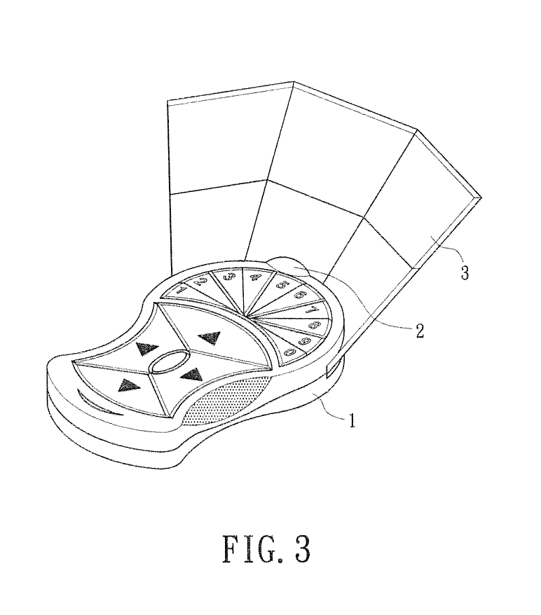

The instant disclosure provides a portable information product having a built-in projection device. FIG. 1 shows a first embodiment of an interior system according to a portable information product having a built-in projection device of the instant disclosure. As shown in FIGS. 3-6, the portable information product may be a cellular phone, a portable computer, a personal digital assistant, or any type of portable information product. The portable information product comprises a data processing device 1 and a built-in projection device 2.

The data processing device 1 has a main circuit module 10. The main circuit module 10 has a microprocessor 101, various essential program processors (not shown), various essential memories 102, and other electronic elements, for processing data thereof and forming an output signal from the data.

The data processing device 1 has a storage device 11 and an application circuit module 12. The storage device 11 may be a hard disk driver, a card reader, or any type of device that provides storage functions. The storage device 11 electrically connects to the main circuit module 10 for storing data of the data processing device 1. The application circuit module 12 may be a charging circuit module, an audio circuit module, or any type of functional application circuit module. The application circuit module 12 electrically connects to the main circuit module 10 for processing data stored on the data processing device 1.

The built-in projection device 2 is disposed in the data processing device 1 and electrically connects to the main circuit module 10. The projection device 2 has a light source 20 and a projector 21. The light source 20 may be a light emitting diode (LED) for generating light. The projector 21 may be an image forming structure composed of optical elements and electronic elements.

As shown in FIG. 1, the data processing device 1 also has a switching circuit module 13, a display device 14, and a projection and amplifying circuit module 15. The switching circuit module 13 electrically connects between the main circuit module 10 and the projection device 2, and between the main circuit module 10 and the display device 14. The display device 14 may be a liquid crystal display (LCD). The projection and amplifying circuit module 15 electrically connects between the main circuit module 10 and the projector 21 of the projection device 2, and is between the switching circuit module 13 and the projector 21, for processing and amplifying output signals from the main circuit module 10.

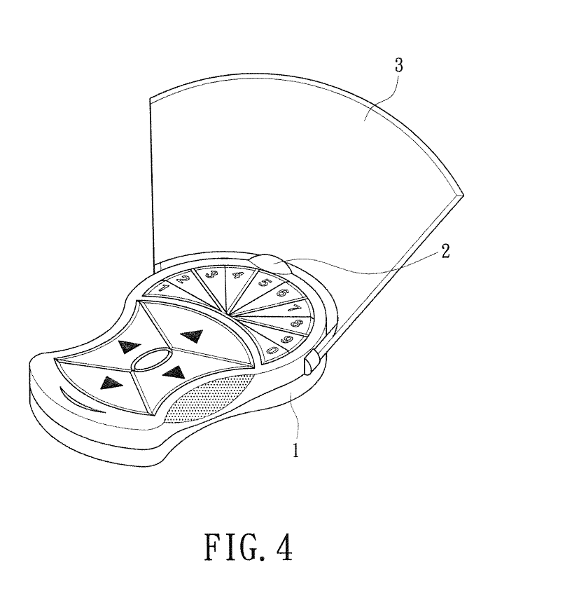

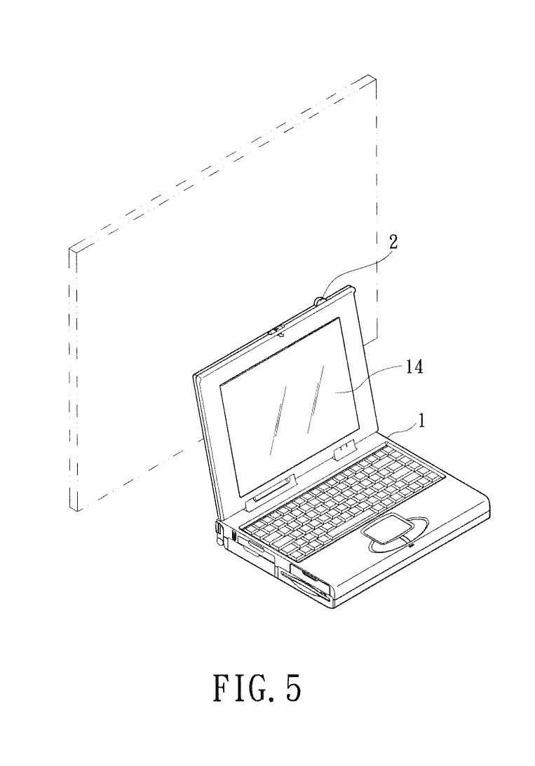

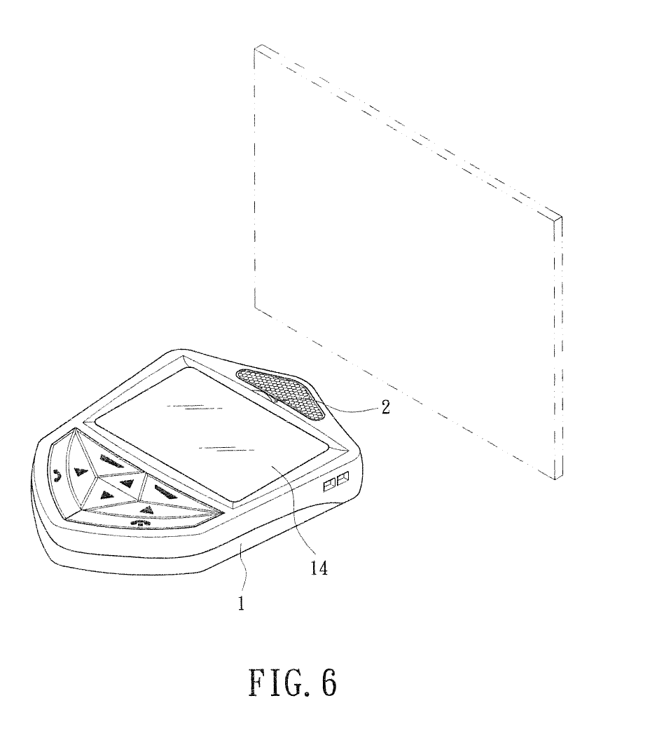

The portable information product having a built-in projection device of the instant disclosure uses the projection device 2 and/or the display device 14 to display the output signal formed from the data thereof. The output signal is alternatively transmitted to the projection device 2 and/or the display device 14 through the switching circuit module 13. The portable information product may further comprise a screen 3 for projection. As shown in FIG. 3, the screen 3 retrievably connects to the data processing device 1. As shown in FIG. 4, the screen 3 detachably assembles to the data processing device 1. When a user uses the projection device 2 to display the data of the data processing device 1, the output signal is transmitted to the projector 21 via the projection and amplifying circuit module 15, and the light source 20 generates a light. The light and the output signal are transmitted to the projector 21 to form an image, and the projector 21 projects the image onto the screen 3 outside the data processing device 1. As a result, more people can view the image simultaneously. As shown in FIG. 5 and FIG. 6, the portable information product may also not have a screen for projection. In this case, the projector 21 directly projects the image onto an appropriate surface outside the data processing device 1. The user may also use the display device 14 to display data stored on the data processing device 1, or use the projection device 2 and the display device 14 to display data stored on the data processing device 1 simultaneously.

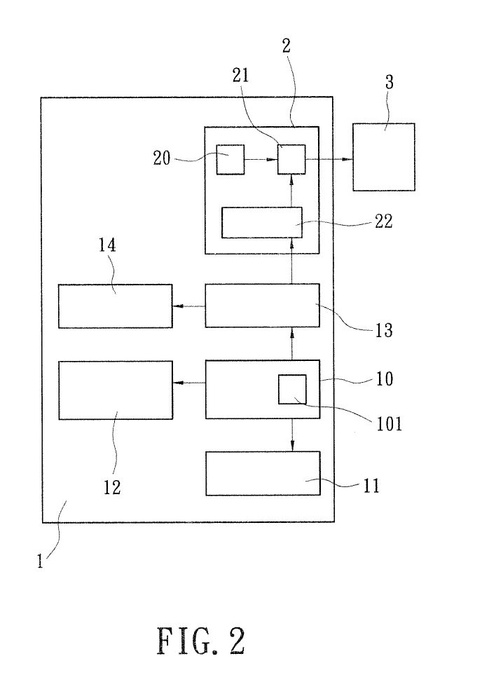

FIG. 2 shows a second embodiment of an interior system according to a portable information product having a built-in projection device of the instant disclosure. The difference between FIG. 2 and FIG. 1 is the projection and amplifying circuit module 22. In FIG. 2, the projection device 2 has a projection and amplifying circuit module 22 electrically connecting between the main circuit module 10 and the projector 21 of the projection device 2, and is between the switching circuit module 13 and the projector 21. The output signal is transmitted to the projector 21 via the projection and amplifying circuit module 22. Therefore, the projection and amplifying circuit module may be integrated with the projection device or the data processing device.

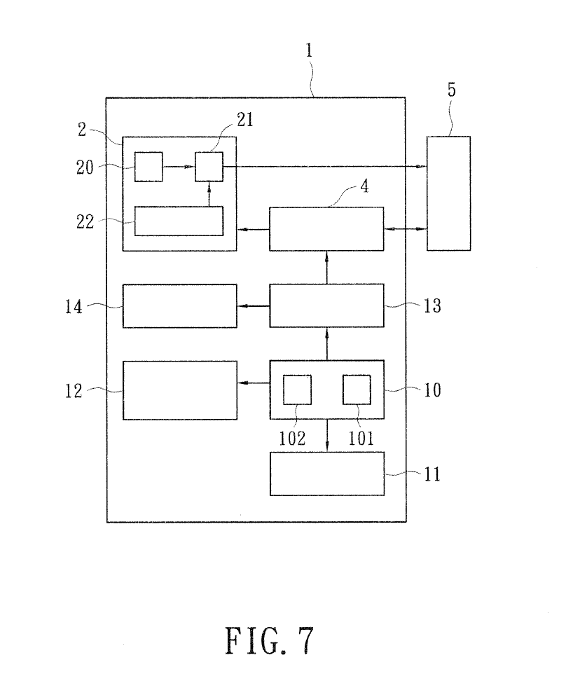

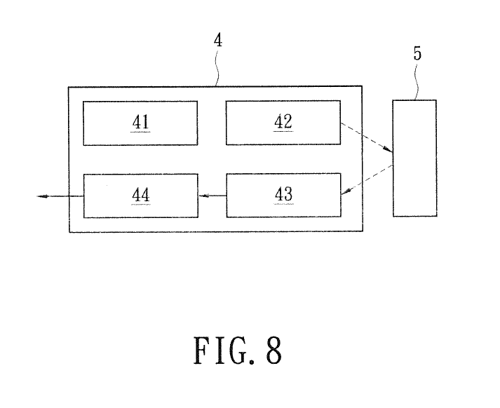

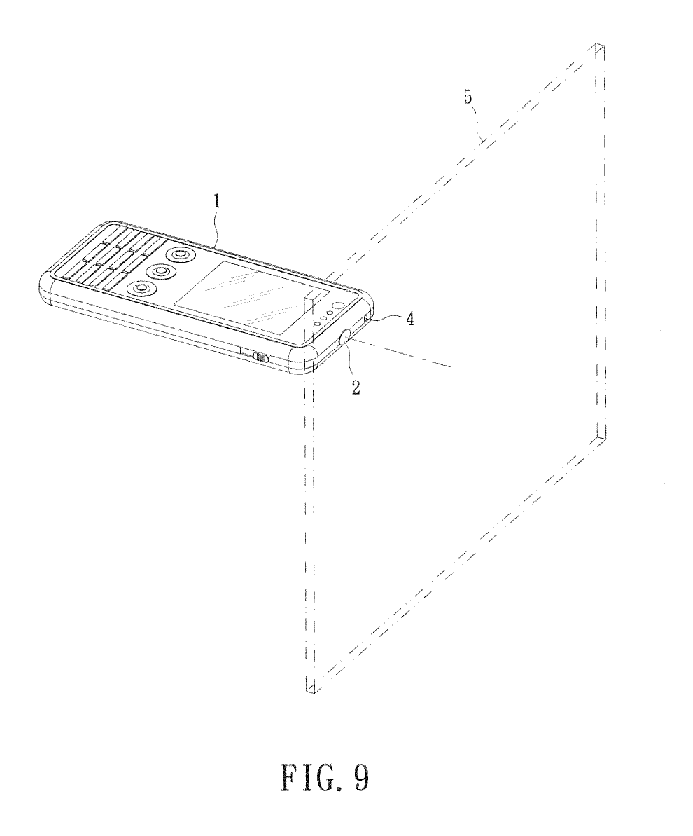

FIGS. 7-9 show a third embodiment of an interior system according to a portable information product having a built-in projection device of the instant disclosure. The difference between the third embodiment and the first embodiment is described as follows.

The projection device 2 has a fixed focal length. The portable information product further has a distance measuring device 4. The distance measuring device 4 is disposed in the data processing device 1 and electrically connected between the switching circuit module 13 and the projection device 2. The distance measuring device 4 is used for sensing a distance 5 between the projection device 2 and a surface which in front of the projection device 2. When the distance is approximately equal to the fixed focal length, the distance measuring device 4 transmits the output signal to the projection device 2 via switching circuit module 13 for generating a light by the light source 20 and forming an image by the projector 20, thereby projecting the image to the surface 5.

The distance measuring device 4 has a source circuit 41, an infrared emitter 42, an infrared receiver 43, and a processing unit 44. The source circuit 41 can transport energy to the distance measuring device 4 by transforming the energy of the battery of the portable information product. The infrared emitter 42 can be an infrared diode that emits an infrared light 421 to the surface 5, and the appropriate wavelength of the infrared light 421 is between 830 nm to 950 nm. The infrared receiver 43 can be a thermistor or a semiconductor unit. The infrared receiver 43 is used for receiving the infrared light 421 which reflecting by the surface 5. The infrared receiver 43 transmits a digital signal to the processing unit 44 according to the received infrared light 421. The processing unit 44 calculates the distance according to the digital signal and transmits the output signal to the projection device 2 if the processing unit 44 judges that the distance is approximately equal to the fixed focal length.

The distance measuring device 4 may be an infrared distance measuring device in the third embodiment. However, practically, the type of the distance measuring device 4 is not limited thereto. For example, the distance measuring device 4 can be a laser distance measuring device (not shown) or a supersonic distance measuring device (not shown).

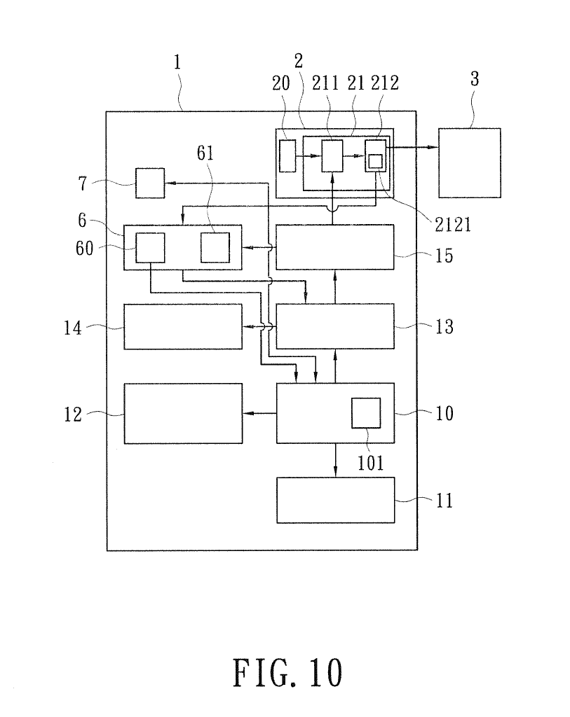

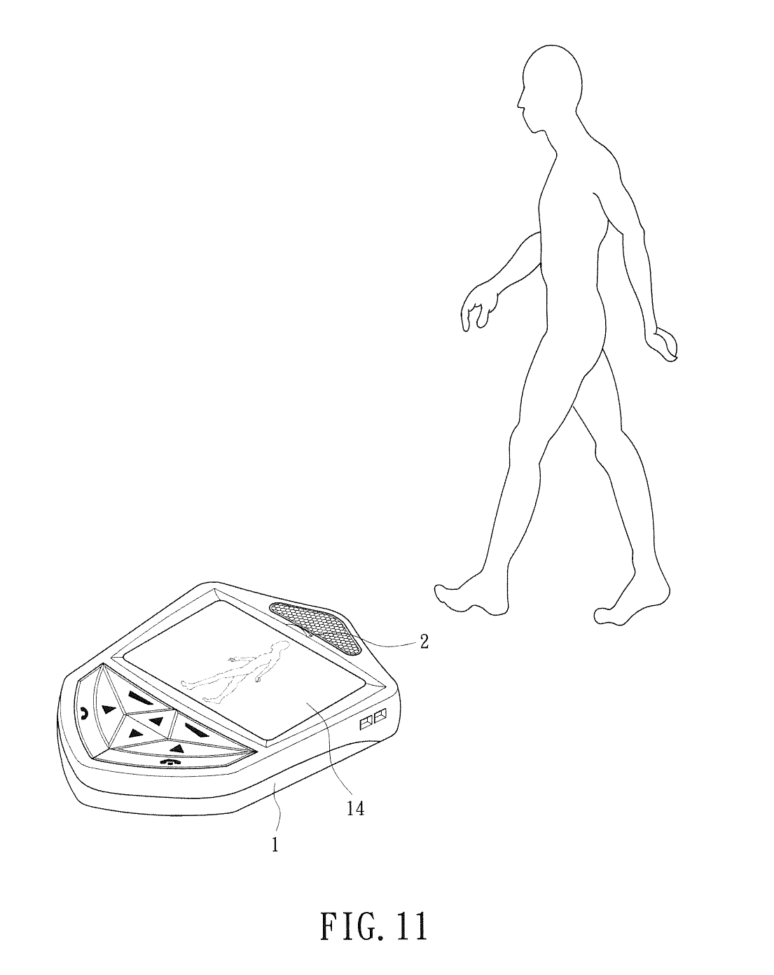

FIGS. 10-11 show a fourth embodiment of an interior system according to a portable information product having a built-in projection device of the instant disclosure. The difference between the fourth embodiment and the first embodiment is described as follows.

The projector 21 has a imaging unit 211 and a lens 212. The imaging unit 211 electrically connects to the amplify circuit module 15. The lens 212 has a focal changing unit 2121 changing the focal of the lens 212.

The portable information product further has a photograph module 6. The photograph module 6 is disposed in the data processing device 1. The photograph module 6 has an image sensor 60 and a optical filter 61. The image sensor 60 electrically connects to the switching circuit module 13. According to the requirement of the producer, the image sensor 60 can be a CCD or a CMOS.

The portable information product has two mode, one is the projection mode, and the other one is photograph mode. In the projection mode, the lens 212, the imaging unit 211 and the light source 20 are on the same optical path. When the output signal is transmitted to the projection device 2 through the switching circuit module 13, the imaging unit 211 displays the image wanted to be projected, and the light source 20 emittes a light pass through the imaging unit 211 and the lens 212. Therefore, the lens 212 projects the image said above on the screen 3.

In the photograph mode, the image sensor 60, the optical filter 61, and the lens 212 are on the same optical path. When the output signal is transmitted to the photograph module 6 through the switching circuit module 13, the image sensor 60 turns on and receives a light through the lens 212, and the image sensor 60 transforms the photon into the electric sign transmitted to the main circuit module 10. Moreover, the display device 14 displays the image said above. The portable information product further has a photoflash 7 electrically connecting to the main circuit 10. In the insufficient light circumstances, the photoflash 7 emits the light.

As indicated above, the photograph module 6 and the imaging unit 211 both correspond to the lens 212. To avoid optical interference, the switching circuit module 13 can change the position of the photograph module 6 and the imaging unit 211.

Additionally, the portable information product is suitable applied on a cell phone.

As indicated above, the portable information product having a built-in projection device of the instant disclosure has the following advantages: (1) The built-in projection device is disposed in the data processing device, so that the output signal formed by the data processing device is outputted via the built-in projection device, so that data stored on the data processing device is easier to view. (2) The screen retrievably connects to the data processing device, or the screen detachably assembles onto the data processing device, or the portable information product may not have a screen, so that the portable information product is more convenient. (3) The projection device can project the image to the surface, when the distance between the projection device and the surface is approximately equal to the fixed focal length of the projection device. (4) The portable information product comprises the photograph module, and the photograph module and the imaging unit both correspond to the same lens, so that the portable information product can prove the projection mode and the photograph mode.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A portable information product capable of projecting to a surface, the portable information product comprising:
an amplifying circuit;
a data processing device having a main circuit module having a microprocessor and a plurality of memories for processing data thereof and forming an output signal from the data, and having a storage device electrically connecting to the main circuit module for storing data of the data processing device, and having an application circuit module including a charging circuit module;
a built-in projection device disposed in the data processing device the projection device having a light source and a projector, the projector having a imaging unit and a lens;
a display device disposed in the data processing device;
a switching circuit module disposed in the data processing device and electrically connecting to the projection device and the display device; and
a photograph module disposed in the data processing device, and the photograph module electrically connecting to the switching circuit module;
wherein the built-in projection device and the amplifying circuit module are electrically connected between the main circuit module and the projector of the projection device, and the output signal is transmitted to the projector via the amplifying circuit module, and the photograph module and the imaging unit alternatively correspond to the lens.

2. The portable information product as claimed in claim 1, wherein the photograph module has an image sensor and a optical filter, and the image sensor electrically connects to the switching circuit module, and the image sensor and the lens are on the same optical path.

3. The portable information product as claimed in claim 2, wherein the switching circuit module changes the position of the photograph module and the projection device.

4. The portable information product as claimed in claim 3, further comprising a photoflash, wherein the photoflash electrically connects to the switching circuit module.

5. The portable information product as claimed in claim 2, wherein the lens includes a focal changing unit, the focal changing unit electrically connects to the main circuit module, and the focal changing unit changes the focal of the lens.

6. The portable information product as claimed in claim 2, wherein the image sensor is a CCD.

7. The portable information product as claimed in claim 4, wherein the image sensor is a CMOS.
